(19) United States
(12) Patent Application Publication
(10) Pub. No.: US 2008/0294337 A1
(43) Pub. Date: Nov. 27, 2008

(54) TRAVEL-RELATED INFORMATION PROCESSING SYSTEM

(76) Inventors: Christopher James Dawson, Arlington, VA (US); Barry Michael Graham, Silver Spring, MD (US); Rick Allen Hamilton, II, Charlottesville, VA (US); Garfield Winston Vaughn, South Windsor, CT (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/752,642

(22) Filed: May 23, 2007

(51) Int. Cl. G01C 21/30

(52) U.S. Cl. 701/209; 701/213

(57) ABSTRACT

A method and implementing computer system are provided in which users are enabled to provide spontaneous routing and driving condition information to a data base which is made available to other drivers on a real-time basis. Users are also enabled to define new routes between travel points and upload new route information for access by other users of the system. In an exemplary embodiment, wireless communication techniques are implemented to transfer data from a GPS device in an automobile to a data base on a central server to provide other users of the system who have access to the data base with the current status of dynamic driving conditions.

### FIELD OF THE INVENTION

The present invention relates generally to information processing systems and more particularly to a methodology and implementation for enabling user input for vehicle travel routes.

### BACKGROUND OF THE INVENTION

Computerized mapping systems are being developed in order to assist motorists in determining preferred routes in traveling between two or more locations. Examples of computerized mapping systems include: Map Quest™, Yahoo! Maps™, SMART pages™, AutoPilot™, and Rand McNally™. In addition to the above examples, Mercedes Benz and BMW have incorporated similar computerized mapping systems into their automobiles' on-board computer systems.

In general, current computerized mapping systems allow a user or operator to enter a starting point and a destination point. The computerized mapping system may access a map database containing road information. Each road in the database may be broken up into segments. The segments may begin and end at intersections, speed zones, or a change in the number of lanes. The information of a road segment in the map database may include: the length of the segment, speed limit, and which road segments connect to the endpoints of the segment. The mapping system may plot out a number of probable routes comprised of road segments connecting the starting point and the destination. An estimated travel time for each route may be calculated by summing the quotient of the distance traveled in a particular speed zone by the speed limit of the zone. A route may then be selected based on the shortest estimated time required to travel the route. The travel route may then be communicated to the operator.

Existing systems are frequently not up to date with regard to traffic delays which may be encountered while traveling the selected route. Such delays may be caused by new construction and/or detours which are not taken into account when a pre-programmed navigation program is created. Moreover, spontaneous or real-time factors, such as disabled vehicles or weather-related road conditions which may affect travel routes, are not taken into account at all. These shortcomings result in mapping programs which provide incorrect information since traffic delays are not programmed into a calculation of the travel time to arrive at a designated destination. Instead, many current systems use the posted speed limit for travel segments in calculating travel time and traffic delays are not considered.

Further, there is no current system which provides users with current information regarding the aesthetics and/or other factors of a trip. For example, navigation systems do not provide current information regarding autumn tree color changes or snow accumulation along predetermined routes in a timely manner. When there are several routes to choose from, drivers may prefer to take a route with better scenic views of color changes at the time that the driver is actually taking the trip. Such spontaneous information is not available from pre-programmed static navigation systems.

Since current vehicle navigation systems use static, rather than dynamic information, changes can not be implemented in a timely manner. In addition to being out of date, the “best” route offered is usually defined by the shortest distance or time between the start and end. The updating and distribution of new routes using the currently available methods is not very efficient. The accuracy of this information is very important because of the many very critical scenarios in which auto routing is used. As such static maps are distributed, there is a high probability that some of the routes that have been defined no longer even exist because of new roads being created, or because of temporary construction that has caused a major portion of a road to be unusable.

Routes are generated primarily based on the time to get to a destination, or the number of miles to a destination, the navigation routes follow either the quickest (chronological) or shortest (Euclidean) distance. These two attributes/criteria may, however, only be important when a user is commuting to work during the week. On the weekends, spending time with family and relaxing may be more important than saving time by following pre-programmed and “most efficient” route between points. At best, current systems provide only whether or not a particular route is “scenic” or “fastest” but no further detail, and no current status of changing conditions along a selected route.

Thus there is a need for an improved methodology and implementing mapping system which provides more accurate and spontaneous information to a user regarding expected travel routing and current on-course conditions of a vehicle in traveling between selected starting points and destinations.

### SUMMARY OF THE INVENTION

A method and implementing computer system are provided in which users are enabled to provide spontaneous routing and driving condition information to a data base which is made available to other drivers on a real-time basis. Users are also enabled to define new routes between travel points and upload new route information for access by other users of the system. In an exemplary embodiment, wireless communication techniques are implemented to transfer data from a GPS device in an automobile to a data base on a central server to provide other users of the system who have access to the data base with the current status of dynamic driving conditions.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of a user navigation system in accordance with the present invention;

FIG. 3 is a functional block diagram of the various units which may be included in the user navigation system in accordance with one embodiment of the present invention;

FIG. 4 is a flow chart illustrating an exemplary operation in one embodiment of the present invention; and

FIG. 5 is a flow chart illustrating an exemplary verification process which may be implemented in conjunction with the present invention.

### DETAILED DESCRIPTION

The various methods discussed herein may be implemented within a typical computer system which includes processing means, memory, updateable storage, input means and display means, in combination with a global positioning system (GPS) and communication means for communicating information between individual user systems and a central server system accessible by users of the system. Since the individual components of a computer system which may be used to implement the computer functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

In accordance with the present invention, users of a navigational system are allowed to record new routes and also to assign values to routes and make such information available to all users. If a user drives a route frequently and thinks others would benefit from knowing about the route, then they are enabled to define descriptive attributes that would be related to that route. These values are presented to users when trying to select a route. The act of assigning these values is known as tagging. In addition to such “user tagging”, the user will also be able to rate a road/route. This information will be made available to others through user recording, rating, tagging, and sending it to a centralized database, at which time the route becomes available for access to other users. As others use this defined route, they can also rate and tag it with their own personal values. Publishing the new routes to other users may also be dependent on rules. For instance, a new route may not be published until at least some number of users (a minimum threshold) have rated it, or until some form of user registration (and the knowledge of the individual that registration brings) has occurred. Such rules would help with the validation of a new route/road so that new routes could not be added and accessed by other drivers until they have been validated by other drivers. Applied rating values can simply be numerical (1-10) where “1” could mean “not recommended” and “10” could mean “highly recommended.” In another embodiment, a t“tag” would state the basis for the recommendation. For example, a route tag may state “highly recommended for scenic viewing” or “highly recommended for niche shops”. Users of this data will use route rating to aid in making a decision about a route. Socially applied tags (Scenic, Windy, Dangerous, Congested, Deserted, Picturesque, HOV, etcetera) that the users assign will be a valuable piece of data that will help a user make a decision to choose a particular route at a current time. Thus, the combination of rating and tags will provide the human assigned values that may be more important than speed and distance, for some users.

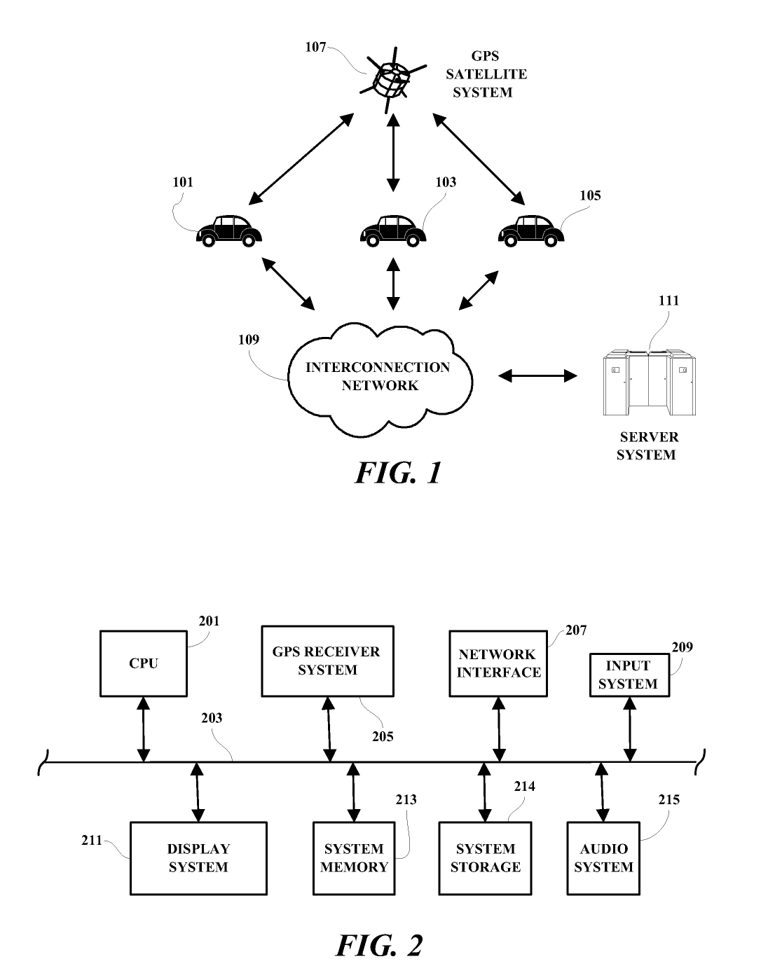

In FIG. 1, a global positioning system (OPS) 107 is in place to transmit location signals to a plurality of vehicles 101, 103 and 105. Each of the vehicles 101-103 includes a GPS system which is operable for receiving location signals from the GPS satellite 107 providing signals representative of the location of each vehicle, respectively. In addition to the GPS system, each vehicle 101-103 includes a navigation processing system which is arranged to communicate with a server 111 through an interconnection network 109, for example the Internet. With the system as shown, vehicles 101-103 are able to determine each vehicle's location at any time and transmit that location information to the server 111 where the vehicle location information is tracked and stored. The server 111 also uses the received location points received from the vehicles 101-103 to develop travel routes which are also stored and made available to other vehicle users who access the server 111.

In FIG. 2, several components of a vehicle's onboard processing system are illustrated. As shown, a CPU 201 is connected to a main bus 203. An onboard GPS receiver system 205 is also connected to the main bus 203. Other systems are also connected to the main bus 203 including, but not limited to, a network interface 207 for communicating with the server 11, an input system 209 for enabling user input to the system, a display system 211 for displaying, inter alia, routing information and selection and other menus to the user, system memory 213 and system storage 214 from which programming may be accessed and executed, and an audio system 215 for playing audio snippets or files, including routing directions, to a user.

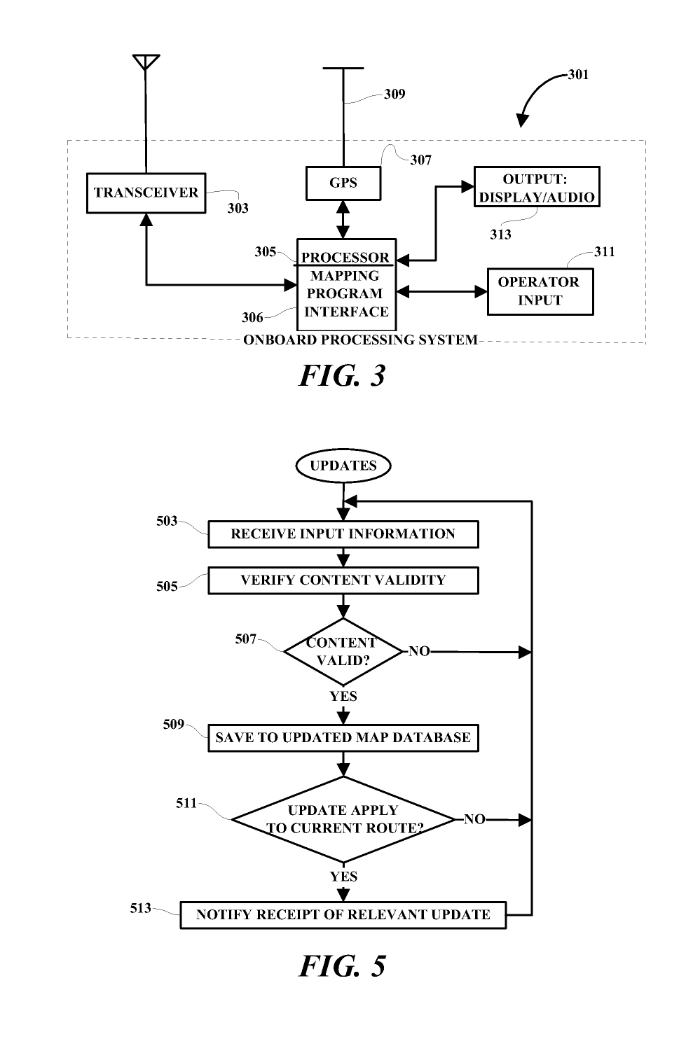

FIG. 3 shows an overall block diagram of an exemplary user system 301 which may be mounted in a user's vehicle. As shown, a transceiver 303 is arranged to communicate with a remote server, for example server 111. Transceiver 303 is coupled to a processor 305 which is, in turn, coupled to a mapping program interface 306. Mapping interface 306 contains interfacing code for communicating with the routing and storage programming for the server 111. Processor 305 also receives an input from the GPS system 307 through antenna 309. The processor 305 is arranged to receive input from a user interface 311. User input may be provided by any of many known input means, including but not limited to, full keyboard, keypad, touch-sensitive screen input, user voiced input and/or selection from a menu presented on a display device. An output unit 313 is also shown coupled to the processor 305 and arranged to provide an audio and/or video output to the system user.

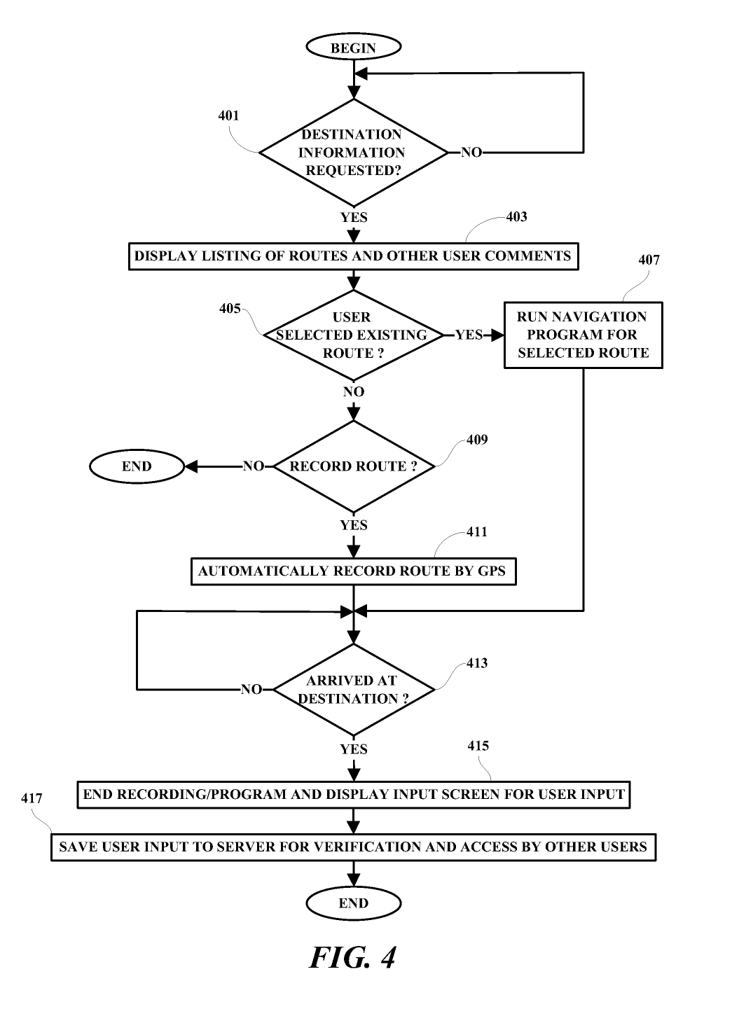

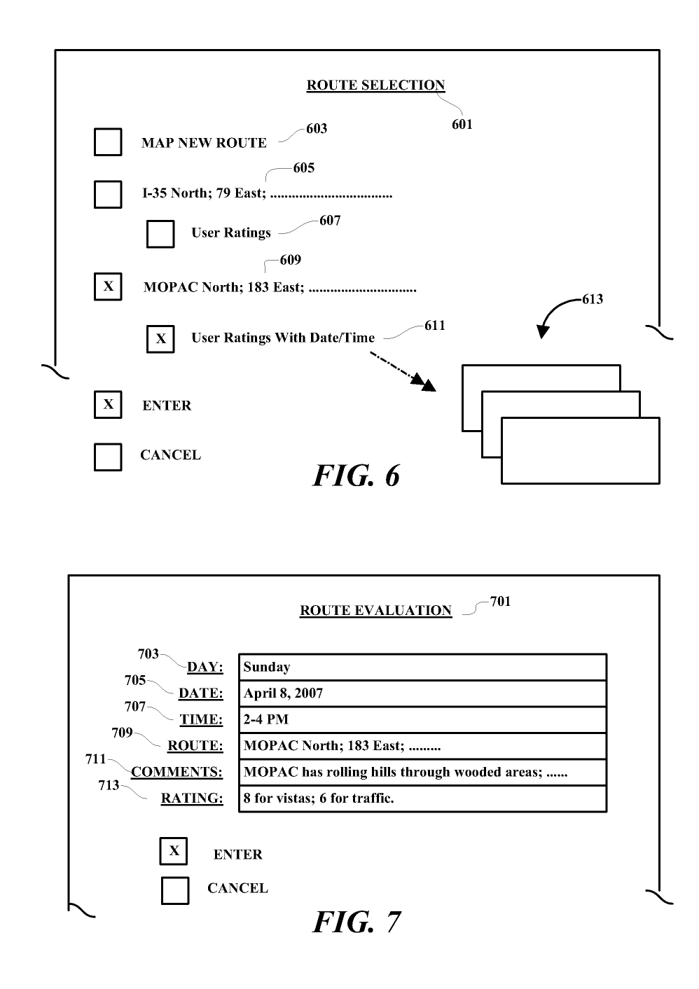

FIG. 4 shows an example of an operational flow sequence for one embodiment of the present invention. As shown, when a user requests routing information to an input destination 401, a listing of possible routes is displayed 403 to the user for selection. The routes listing in the present example, also includes user comments and other user input regarding each route. If the user selects an existing route as displayed 405, then the programmed navigation route selected by the user is audibly and/or visually presented 407 to the user as the user drives his or her vehicle to the input destination. If the user does not select an existing route from the presented listing 405, then a determination is made as to whether or not the user wishes to record a new route 409. The user may then select not to record a new route 409 and the processing is ended. However, if the user wishes to record a route other than the routes presented to the user 409, then the process continue by sampling the user's routing, for example by taking samples from the vehicle's GPS readings along the way, to automatically record 411 the user's route. After the user has arrived at a destination 413 the recording of the user's route is ended 415 and a user input screen is displayed to the user to obtain the user's comments with regard to the route taken, whether it be an existing route 407 or a newly mapped route 411. Arrival at a destination may be determined by several methods including, but not limited to, matching the GPS location of a vehicle to a known GPS location of the destination. The user's input is then saved 417 to the central server 417 for verification and for subsequent access by other system users.

An exemplary verification process is illustrated in FIC 5. As shown, when the user's input is received 503, a verification process is initiated 505 and if the input is found to be valid 507, the user input is saved to a map data base 509. The verification process may be omitted or may be comprised of a simple check to determine if at least two users have provided the same information. In one example, after saving the user input data or after verification, the user input can be spontaneously checked against routes currently being traveled by other users 511 and if any of the other users are traveling the same or related routes, those users may be contacted 513 with the updated information from a user who has just traveled the route. In this manner, all system users can be made aware of current and developing traveling conditions along a given route which has just very recently been traveled by another system user.

FIG. 6 illustrates an example of a route selection screen 601 which may be presented to a user and used to select a travel route to an input destination. As shown, the user may select to map a new route 603 or the user may select one of a number of possible existing routes 605, 609 of record to the user's destination. Associated with each route is an input box 607 and 609, respectively, which may be selected by the user to have pop-up windows 613, for example, displayed containing other user's comments regarding the associated route.

FIG. 7 shows an exemplary route evaluation screen which may be implemented to receive a user's evaluation of a traveled route. As illustrated, there are several fields presented in which a user may provide input, including, but not limited to, the day of travel 703, the date of travel 705, the time of travel 707, the route traveled 709, the user comments 711 and an overall rating 713 which may also include the rated characteristic of the route i.e., on a scale of “1” to “10” an “8” for vistas or scenery and/or “6” for traffic. After a user has input this information and uploaded to the central server 111, the user's information and comments may be automatically made available to other users of the system who may be traveling the same or a parallel route. In this manner, spontaneous and current information regarding current and developing traffic situations is made available to all users of the navigation information system of the present invention.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical or magnetic memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing travel-related information within a vehicle routing system, said method comprising:
storing at least one travel route to a destination;
determining when a first user has completed traveling said one travel route;
enabling said first user to input user comments regarding said travel route; and
storing said first user comments in association with said travel route.

2. The method as set forth in claim 1 wherein said first user comments and said travel route are stored in a system server, said method further including:
enabling access to said stored travel route and said first user comments by users other than said first user.

3. The method as set forth in claim 2 wherein said access to said stored travel route and said first user comments is accomplished by using a wireless coupling between a device used by said first user and said system server.

4. The method as set forth in claim 1 wherein said travel route is determined tracking a route taken by said first user to said destination.

5. The method as set forth in claim 4 wherein said tracking is accomplished using a global position satellite system.

6. The method as set forth in claim 1 wherein said travel route is determined by a menu selection made by said first user from a listing of known travel routes to said destination, said listing being presented on a display device to said first user.

7. The method as set forth in claim 6 and further including:
displaying a tracking option on said display device to said first user, said tracking option selection being operable for enabling a tracking of said first user along a new route; and
storing said new route when it is determined that said first user has completed travel along said new route.

8. A programmed medium, said programmed medium being selectively coupled to processing circuitry, said programmed medium containing indicia readable by said processing circuitry for providing program signals effective for enabling processing travel-related information within a vehicle routing system, said program signals being effective for:
storing at least one travel route to a destination;
determining when a first user has completed traveling said one travel route;
enabling said first user to input user comments regarding said travel route; and
storing said first user comments in association with said travel route.

9. The medium as set forth in claim 8 wherein said first user comments and said travel route are stored in a system server, said program signals being further effective for:
enabling access to said stored travel route and said first user comments by users other than said first user.

10. The medium as set forth in claim 9 wherein said access to said stored travel route and said first user comments is accomplished by using a wireless coupling between a device used by said first user and said system server.

11. The medium as set forth in claim 8 wherein said travel route is determined tracking a route taken by said first user to said destination.

12. The medium as set forth in claim 11 wherein said tracking is accomplished using a global position satellite system.

13. The medium as set forth in claim 8 wherein said travel route is determined by a menu selection made by said first user from a listing of known travel routes to said destination, said listing being presented on a display device to said first user.

14. The medium as set forth in claim 13 and further including:
displaying a tracking option on said display device to said first user, said tracking option selection being operable for enabling a tracking of said first user along a new route; and
storing said new route when it is determined that said first user has completed travel along said new route.

15. A system for enabling processing of travel-related information within a vehicle routing system, said system comprising:
a system server arranged for communicating with a plurality of mapping devices located in a corresponding plurality of vehicles;
means for storing in said system server at least one travel route to a destination;
means for determining when a first user has completed traveling said one travel route;
means for enabling said first user to input user comments regarding said travel route; and
means for storing said first user comments in association with said travel route.

16. The system as set forth in claim 15 wherein said first user comments and said travel route are stored in said system server, said system further including:
means for enabling access to said stored travel route and said first user comments by users other than said first user.

17. The system as set forth in claim 16 wherein said access to said stored travel route and said first user comments is accomplished by using a wireless coupling between a mapping device used by said first user and said system server.

18. The system as set forth in claim 15 wherein said travel route is determined tracking a route taken by said first user to said destination.

19. The system as set forth in claim 18 wherein said tracking is accomplished using a global position satellite system.

20. The system as set forth in claim 15 wherein said travel route is determined by a menu selection made by said first user from a listing of known travel routes to said destination, said listing being presented on a display device viewable by said first user.
